(19) United States
(12) Patent Application Publication
(10) Pub. No.: US 2025/0045020 A1
(43) Pub. Date: Feb. 6, 2025

(54) RANDOM NUMBER GENERATION DEVICE, RANDOM NUMBER GENERATION METHOD, AND ELECTRONIC CONTROL DEVICE

(71) Applicant: DENSO CORPORATION, Kariya-city (JP)

(72) Inventor: Tomoki YOKOYAMA, Kariya-city (JP)

(21) Appl. No.: 18/785,010

(22) Filed: Jul. 26, 2024

(30) Foreign Application Priority Data
Aug. 1, 2023 (JP) 2023-125809

(51) Int. Cl. G06F 7/58

(52) U.S. Cl. CPC G06F 7/584

(57) ABSTRACT

A random number generation device is configured that, when a result of statistical tests as for entropy by a statistical tester is “NG (i.e., Failed),” a seed generator generates a seed based on additional entropy provided by an entropy pool, and then a first PRNG generates a random number based on such a seed. As described above, the random number generation device generates a random number by using the seed not based on an HSM random number but based on additional entropy, in response to a situation in which (a) the result of statistical tests as for entropy by a statistical tester is “NG,” and (b) indeterminacy of entropy is not ensured.

### CROSS REFERENCE TO RELATED APPLICATION

The present application is based on and claims the benefit of priority of Japanese Patent Application No. 2023-125809, filed on Aug. 1, 2023, the disclosure of which is incorporated herein by reference.

### TECHNICAL FIELD

The present disclosure relates to a random number generation device and method for generating random numbers, and an electronic control device equipped with the random number generation device.

### BACKGROUND

There has been known a method for generating entropy in a computing device. In this method, a first repeat timer is set to a first frequency and a second repeat timer is set to a second frequency. A predetermined number of first bits are then collected from a first entropy source at the first frequency, and a specified number of second bits are collected from a second entropy source at the second frequency. The collected first bits and second bits are each provided to a pseudo-random number generator. The pseudo-random number generator performs seeding using the first bit and the second bit.

In the above-described method, a plurality of entropy sources are provided, and the pseudo-random number generator performs seeding using the first bit and second bit collected from these entropy sources. Thus, for example, even when a first entropy source is compromised (security-breached), a message encrypted with a cryptographic key generated by seeding bits from other entropy sources cannot be decoded.

Therefore, all messages can be prevented from being decoded by eavesdroppers.

### SUMMARY

In an aspect of the present disclosure, a random number generation device includes: a first random number generator that is configured to generate, in a first entropy source, a first random number based at least on first entropy that is a true random number generated from a physical phenomenon; a second random number generator that is configured to generate a second random number based on second entropy obtained from a second entropy source; and a determiner that is configured to determine whether indeterminacy as entropy is ensured regarding the first entropy. The first random number generator is further configured to generate the first random number when the determiner determines that indeterminacy is ensured. The second random number generator is further configured to generate the second random number when the determiner determines that indeterminacy is not ensured.

### BRIEF DESCRIPTION OF THE DRAWINGS

Objects, features, and advantages of the present disclosure will become more apparent from the following detailed description made with reference to the accompanying drawings, in which:

FIG. 1 is a configuration diagram showing an example of configuration of a random number generation device according to a first embodiment;

FIG. 2 is a time chart for explaining periodic processing performed by an entropy pool unit to read a timer value of a free-run timer;

FIG. 3 is a flowchart showing a flow of processing up to a time when a seed generator generates a seed based on an HSM random number from an HSM and additional entropy from the entropy pool unit when an ECU is started;

FIG. 4 is a flowchart showing a flow of random number generation processing;

FIG. 5 is a flowchart showing a flow of HSM random number generation processing;

FIG. 6 is a flowchart showing a flow of additional entropy obtaining processing;

FIG. 7 is a flowchart showing a flow of seed generation processing;

FIG. 8 is a configuration diagram showing an example of configuration of a random number generation device according to a second embodiment;

FIG. 9 is a flowchart showing a flow of additional entropy obtaining processing according to the second embodiment;

FIG. 10 is a flowchart showing a flow of additional entropy obtaining processing according to a modification of the second embodiment;

FIG. 11 is a flowchart showing a flow of processing up to a time when a seed generator generates a seed based on an HSM random number from an HSM and additional entropy from the entropy pool unit when starting the ECU according to a third embodiment;

FIG. 12 is a configuration diagram showing an example of configuration of a random number generation device according to a fourth embodiment;

FIG. 13 is a configuration diagram showing an example of configuration of a random number generation device according to a modification example; and

FIG. 14 is a configuration diagram showing an example of the configuration of a random number generation device according to another modification example.

### DETAILED DESCRIPTION

Next, a relevant technology will be described only for understanding the following embodiments.

Here, when it is necessary to generate more perfect random numbers, a true random number generator may be used. The true random number generator generates random numbers by exploiting the randomness caused by unpredictable physical phenomena in physical sources, such as thermal noise generated by diodes and resistors, noise in wireless communication channels, and radioactive decay of isotopes.

However, with true random numbers, there is a possibility that the frequency of bits that appear may be biased, or that the same bits may be generated consecutively. Therefore, a statistical test is sometimes performed to check whether the true random numbers generated by the true random number generator have sufficient indeterminacy as entropy. Then, if the true random numbers pass a statistical test, for example, a pseudo-random number is generated by a pseudo-random number generator using the generated true random numbers as a seed, and the generated pseudo-random numbers are used to perform functions such as encryption and the like, i.e., the functions using random numbers.

On the other hand, if the true random number does not pass the statistical test, no random number may be generated by the pseudo-random number generator because no seed is provided to the pseudo-random number generator. Note that even when a plurality of entropy sources are provided as described above, a similar problem may occur if bits are collected from each entropy source at a different frequency. That is, when bits collected from any entropy source are unsuitable as seeds, the pseudo-random number generator may be not able to generate random numbers until bits used for seeds are collected from other entropy sources. In such a case, there is a possibility that it may become impossible to perform a function that uses random numbers.

It is one objective of the present disclosure, in view of the above-mentioned points, to provide a random number generation device and method that are capable of performing continuous output of random numbers even when true random numbers do not have sufficient indeterminacy, as well as an electronic control device having such a random number generation device and method.

In a first aspect of the present disclosure, a random number generation device includes: a first random number generator that is configured to generate, in a first entropy source, a first random number based at least on first entropy that is a true random number generated from a physical phenomenon; a second random number generator that is configured to generate a second random number based on second entropy obtained from a second entropy source; and a determiner that is configured to determine whether indeterminacy as entropy is ensured regarding the first entropy. The first random number generator is further configured to generate the first random number when the determiner determines that indeterminacy is ensured. The second random number generator is further configured to generate the second random number when the determiner determines that indeterminacy is not ensured.

In a second aspect of the present disclosure, an electronic control device includes the random number generation device described above.

In a third aspect of the present disclosure, a random number generation method performed by at least one processor includes: generating a first random number based at least on a first entropy that is a true random number generated by physical phenomenon in a first entropy source; determining whether indeterminacy as entropy is ensured for the first entropy; generating the first random number upon determining that the indeterminacy of the first entropy is ensured; and generating a second random number based on second entropy obtained from a second entropy source upon determining that indeterminacy of the first entropy is not ensured.

In a fourth aspect of the present disclosure, a random number generation device includes at least one of (i) a circuit and (ii) a processor having a memory storing computer program code. The at least one of the circuit and the processor is configured to cause the random number generation device to: generate, in a first entropy source, a first random number based at least on first entropy that is a true random number generated from a physical phenomenon; generate a second random number based on second entropy obtained from a second entropy source; and determine whether indeterminacy as entropy is ensured regarding the first entropy. The at least one of the circuit and the processor is further configured to cause the random number generation device to: generate the first random number upon determining that indeterminacy is ensured; and generate the second random number upon determining that indeterminacy is not ensured.

According to the above-described random number generation device and method, and the electronic control device having the random number generation device, it is determined whether the first entropy, which is a true random number generated from a physical phenomenon in the first entropy source, ensures indeterminacy as entropy. Then, it is determined that the indeterminacy of the first entropy is not ensured, a second random number is generated based on the second entropy obtained from the second entropy source. In such manner, it is configured that the second random number is generated in response to a determination that the indeterminacy of the first entropy is not ensured. Therefore, even when true random numbers do not have sufficient indeterminacy, it is possible to perform continuous generation of random numbers, that is, to prevent a situation in which random numbers are not output.

The following will describe embodiments of the present disclosure with reference to the drawings. Note that the same or similar components are denoted by the same reference numerals throughout a plurality of drawings, and description thereof may be omitted. When only a part of a configuration is described in each embodiment, the configurations of other embodiments previously described can be applied to the other parts of such configuration. In addition to the combination of the configurations explicitly described in the description of each embodiment, the configurations of multiple embodiments may also be partially combined even when not explicitly described as long as there is no difficulty in the combination.

### First Embodiment

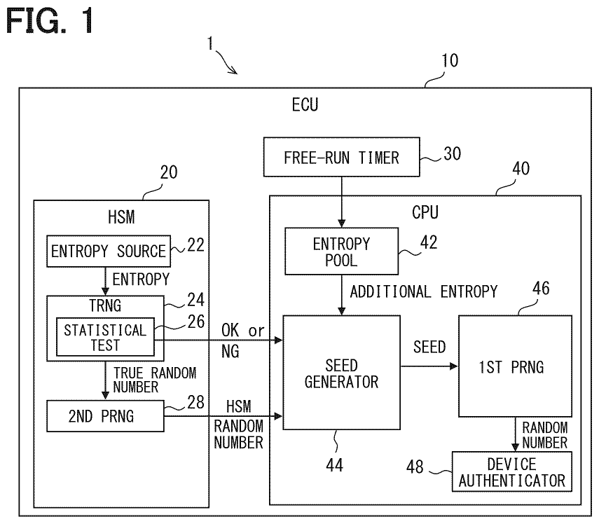

FIG. 1 is a configuration diagram showing an example of configuration of a random number generation device 1 according to the present embodiment. As shown in FIG. 1, the random number generation device 1 can be configured using an electronic control unit (ECU) 10 including at least one processor. The ECU 10 shown in FIG. 1 includes a hardware security module (HSM) 20, a free-run timer 30, and a central processing unit (CPU) 40, which is an example of at least one processor. Further, although not shown, the ECU 10 also includes memories such as RAM and ROM, and peripheral devices such as I/O, an AD converter, a communication device and the like.

The HSM 20 includes an entropy source 22, a true random number generator (TRNG) 24, and a second pseudo-random number generator (PRNG) 28. The entropy source 22 includes, for example, a sensor that detects a physical quantity in a physical phenomenon such as thermal noise of a diode or resistor, noise of a wireless communication channel, or radioactive decay of an isotope. Then, the entropy source 22 generates and outputs entropy from the physical quantity in the physical phenomenon detected by the sensor. That is, the entropy source 22 corresponds to a first entropy source. The entropy generated by the entropy source 22 is provided to the TRNG 24.

The TRNG 24 outputs the given entropy as a true random number when indeterminacy as entropy is ensured with respect to the given entropy. On the other hand, the TRNG 24 does not output the given entropy as a true random number when indeterminacy as entropy is not ensured with respect to the given entropy. Therefore, the TRNG 24 includes a statistical tester 26 for testing whether indeterminacy as entropy is ensured. The statistical tester 26 conducts statistical tests such as checking, for example, whether there is any bias in the frequency at which “1” bits and “0” bits appear in entropy, and/or whether the same bits are generated consecutively more than a predetermined number of times and the like. However, examples of statistical tests are not limited to the above, and any statistical test that can test whether indeterminacy as entropy is ensured can be applied.

The statistical tester 26 provides the results of the statistical test to the TRNG 24 and also outputs them to a seed generator 44, which will be described later. Note that the statistical tester 26 does not need to be provided inside the TRNG 24, and may be provided outside the TRNG 24.

The second PRNG 28 uses the true random number generated by the TRNG 24 as a seed (that is, an initial value of an internal state) to generate HSM random numbers (i.e., pseudo-random numbers), which are irregular bit strings, according to a predetermined algorithm. As a predetermined algorithm, for example, an AES (Advanced Encryption Standard) encryption function that generates an output based on an encryption key and an internal state can be used. The second PRNG 28 can further generate another HSM random number by, for example, updating the internal state using the generated HSM random number. The HSM random number generated by the second PRNG 28 is output to the seed generator 44, which will be described later.

Here, it takes a certain amount of time for the entropy source 22 to output entropy that is usable as a true random number. On the other hand, since the HSM 20 includes the second PRNG 28, when a new random number is required, the HSM 20 can immediately output the HSM random number from the second PRNG 28. Therefore, by generating HSM random numbers from the second PRNG 28 using the true random numbers generated by the TRNG 24 as seeds, it is possible to generate random numbers at high speed while ensuring security.

The free-run timer 30 is reset to 0 (zero) when the ECU 10 is started or reset, and thereafter continues to count up at a predetermined period.

The CPU 40 executes a program stored in the ROM while using the RAM as a temporary storage area, thereby performing predetermined processing (control) according to the program. Therefore, it can be said that the CPU 40 constructs a plurality of functional units by executing a plurality of instructions included in the program. In FIG. 1, some of the functional units constructed by executing a program are shown as blocks. As shown in FIG. 1, the functional units include an entropy pool 42, a seed generator 44, a first PRNG 46, and a device authenticator 48.

Note that the CPU 40 may be singular or plural. Further, the program storage medium is not limited to ROM. For example, various storage media such as HDD or SSD can also be adopted. Further, the CPU 40 is an example of a processor, and instead of or in addition to the CPU, a processor such as an MPU, GPU, or DFP may also be used. MPU is an abbreviation for Micro-Processing Unit. GPU is an abbreviation for Graphics Processing Unit. DFP is an abbreviation for Data Flow Processor. The ECU 10 may be realized by combining multiple types of arithmetic processing units such as a CPU, MPU, GPU, DFP and the like. Further, the ECU 10 may be realized as an SoC. SoC is an abbreviation for System on Chip. Alternatively, the ECU 10 may be realized using ASIC or FPGA. ASIC is an abbreviation for Application Specific Integrated Circuit. FPGA is an abbreviation for Field-Programmable Gate Array.

For example, the entropy pool 42 periodically performs processing for reading a timer value of the free-run timer 30. Then, for example, 1 bit of LSB (Least Significant Bit) of the read timer value is obtained and pooled. Then, the number of pooled bits reaches the number of bits required as entropy, the pooled bit string is output as additional entropy. In this example, the free-run timer 30 corresponds to a second entropy source, and additional entropy corresponds to a second entropy.

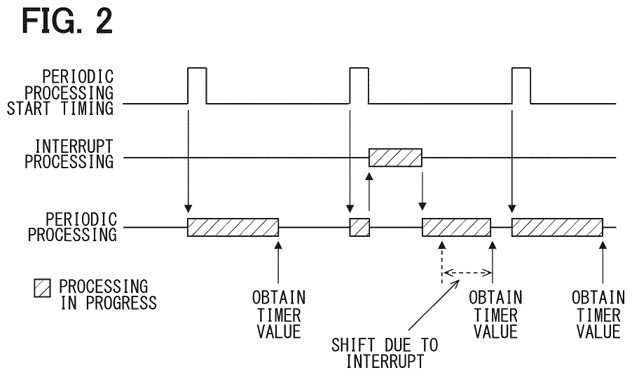

For example, as shown in FIG. 2, the entropy pool 42 performs a periodic processing for reading the timer value of the free-run timer 30 every time a periodic processing start timing arrives. For example, as shown in FIG. 2, a timer value is read by the entropy pool 42 immediately before an end of the periodic processing. Here, in the CPU 40, various kinds of processing are performed in addition to the periodic processing for reading the timer value. These various types of processing include interrupt processing, which has higher importance than periodic processing, and is processed with priority over other processing. Therefore, even when reading the timer value through periodic processing is attempted as shown in FIG. 2, the timing at which the timer value is actually read will not be at a constant period, and may vary due to delays caused by interrupt processing. Therefore, additional entropy is generatable from the timer value of the free-run timer 30.

The seed generator 44 receives the results of the statistical test of entropy from the statistical tester 26. Further, the seed generator 44 takes in the HSM random number from the second PRNG 28 and additional entropy from the entropy pool 42 as input data for generating a seed to be given to the first PRNG 46. When the results of the statistical test of entropy is “OK,” the seed generator 44 performs processing to generate a seed based on the HSM random number and the additional entropy. For example, the seed generator 44 may generate one output data compressed to an arbitrary number of bits from two pieces of input data using a one-way function such as a Miyaguchi-Preneel compression function or the like. One-way functions are mainly used for hash value generation due to their strong collision resistance. Therefore, a one-way function can be considered as a type of cryptographic hash function. Cryptographic hash functions can prevent loss of entropy (indeterminacy) when generating seeds from two input data because the probability of obtaining the same output data from different input data is very low. However, processing for generating a seed is not limited to using the cryptographic hash function described above. For example, the seed generator 44 may generate a seed by performing an XOR operation on the HSM random number and the additional entropy. Alternatively, the seed generator 44 may employ any other processing that combines HSM random numbers and additional entropy to generate seeds.

On the other hand, when the result of the statistical test of entropy is “NG (i.e., Failed),” the seed generator 44 performs processing of generating a seed based only on additional entropy. In such case, the seed generator 44 may directly provide additional entropy as a seed to the first PRNG 46. Alternatively, the seed generator 44 may perform predetermined processing such as AES encryption processing on additional entropy, and may provide the output of the predetermined processing to the first PRNG 46 as a seed.

For example, just like the second PRNG 28, the first PRNG 46 is a unit that generates random numbers (i.e., pseudo-random numbers) that are irregular bit strings according to a predetermined algorithm using the seed from the seed generator 44 as an initial value of the internal state. Further, the first PRNG 46 can also generate another random number by updating its internal state, for example, using the generated random number.

The device authenticator 48 uses random numbers to authenticate whether or not a target device communicating with the ECU 10 is a legitimate device. At this time, the random number can be used, for example, to generate a challenge code when performing challenge-response authentication. However, the device authenticator 48 is an example of a case where random numbers are used, and random numbers can also be used for other purposes. For example, random numbers are used (a) to create encryption keys for encryption when communicating with other devices, (b) to overwrite and erase the previous encryption key when updating the encryption key, and the like.

As described above, in the present embodiment, when the result of the statistical test of entropy in the statistical tester 26 is “OK,” that is, when it is determined that indeterminacy as entropy is ensured, a seed is generated by the seed generator 44 based on the true random number and additional entropy. The first PRNG 46 then generates a random number based on the seed. In such manner, since the seeds are generated based at least on true random numbers, the first PRNG 46 can generate random numbers of highly entropic (that is, with high indeterminacy).

On the other hand, when the result of the statistical test of entropy in the statistical tester 26 is “NG (i.e., Failed),” that is, when it is determined that indeterminacy as entropy is not ensured, then the seed generator 44 generates a seed based on additional entropy. The first PRNG 46 can then generate random numbers based on the seed. In such manner, according to the present embodiment, it is configured that the random number generation device 1 uses a seed based not on an HSM random number but on additional entropy in response to a determination that indeterminacy as entropy is not ensured, for generating random numbers. Therefore, by using the random number generation device 1 according to the present embodiment, even when true random numbers do not have sufficient indeterminacy, it is possible to perform continuous generation of random numbers, that is, to prevent occurrence of a situation where random numbers are not output.

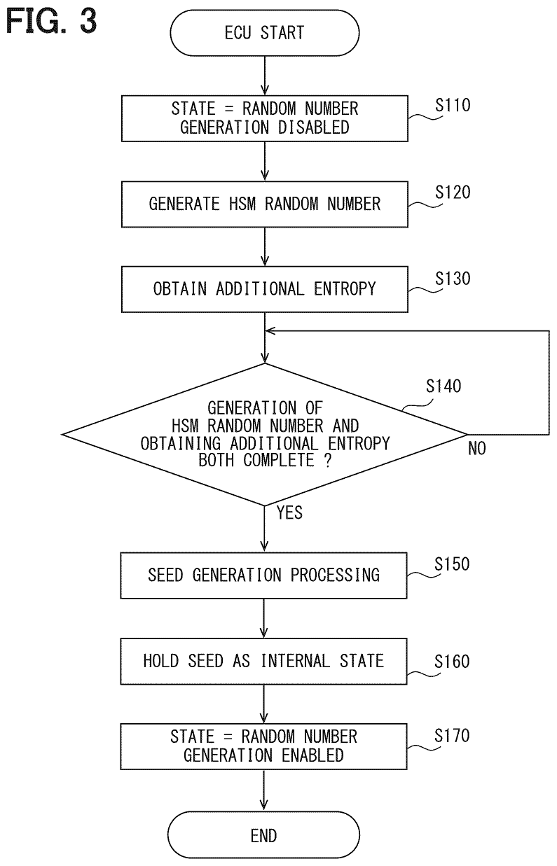

Next, the flow of processing of each functional unit shown in each of the blocks in FIG. 1 will be explained in detail with reference to flowcharts in FIGS. 3 to 7. First, a flowchart in FIG. 3 will be explained. The flowchart in FIG. 3 shows a flow of processing up to a time when the seed generator 44 generates a seed based on the HSM random number from the HSM 20 and the additional entropy from the entropy pool 42 when the ECU 10 is started (including restart due to reset). Note that the processing shown in the flowchart of FIG. 3 may be performed periodically in order to periodically update the seed and provide it to the first PRNG 46 for improved security. In such case, the first PRNG 46 may be configured to set a limit on the period during which random numbers are generated using a given seed, and to stop outputting random numbers when the seed is not updated by the end of such period.

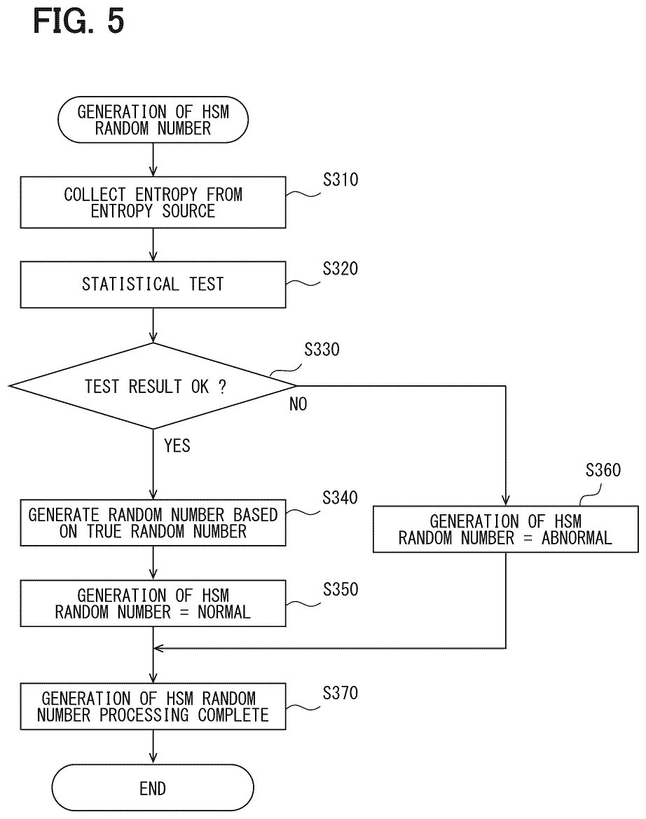

In the first step S110, since a seed has not yet been generated, the CPU 40 sets a random number generation disabled state. In such random number generation disabled state, the first PRNG 46 is unable to generate random numbers, as will be described later. Subsequently in step S120, the HSM 20 performs processing for generating HSM random numbers. Details of such HSM random number generation processing are shown in the flowchart of FIG. 5.

In step S310 of a flowchart of FIG. 5, the TRNG 24 of the HSM 20 collects entropy from the entropy source 22. For example, entropy may be collected bit by bit from an LSB of a detection value of the sensor. When the number of bits of the collected entropy reaches a predetermined number of bits, the statistical tester 26 performs a statistical test of the collected entropy in step S320. Then, in step S330, the statistical tester 26 determines whether the test result is OK, that is, indeterminacy as entropy is ensured, or whether the test result is NG, that is, indeterminacy as entropy is not ensured. Such a determination result is output to the seed generator 44 of the CPU 40, as described above.

The test results of the statistical tester 26 are also provided to the TRNG 24. When the test result is OK, the TRNG 24 outputs the entropy as a true random number to the second PRNG 28. Then, in step S340, the second PRNG 28 performs processing of generating pseudo-random numbers using the input true random numbers as seeds. The generated pseudo-random numbers are given to the seed generator 44 as HSM random numbers. Subsequently in step S350, the HSM 20 stores that the HSM random number has been normally generated. On the other hand, when the test result is NG (i.e., Failed), the TRNG 24 does not output true random numbers to the second PRNG 28. In such case, the second PRNG 28 cannot generate HSM random numbers because it is not given a seed. Therefore, the HSM 20 stores in step S360 that the generation of the HSM random number is abnormal.

Finally, in step S370, the HSM 20 makes a setting indicating that the HSM random number generation processing has been complete, and ends the processing shown in the flowchart of FIG. 5. In such manner, regardless of whether generation of the HSM random number has been performed normally or abnormally, in the final step S370, it is set that the HSM random number generation processing itself has been complete.

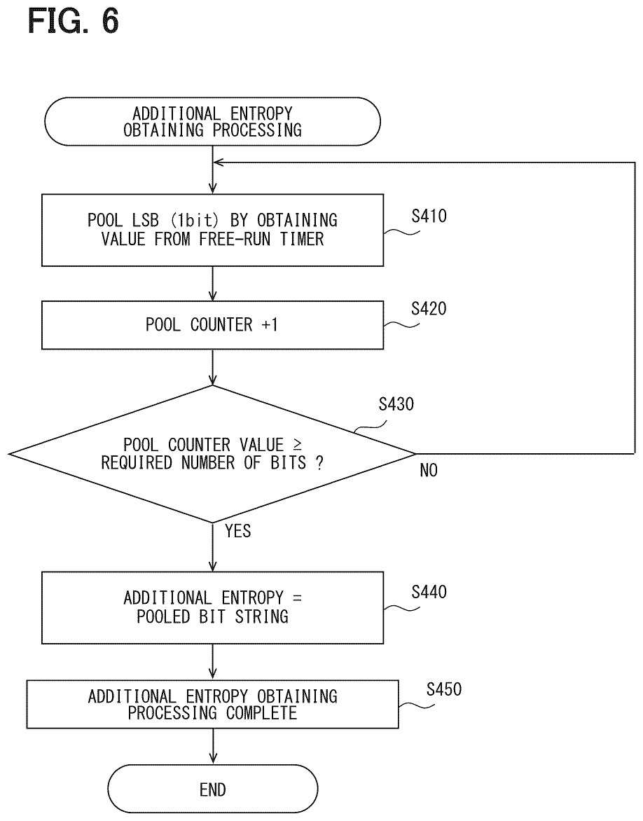

The explanation will be continued by returning to the flowchart of FIG. 3. In step S130, which is performed subsequent to step S120, the entropy pool 42 of the CPU 40 performs additional entropy obtaining processing. Details of such additional entropy obtaining processing are shown in a flowchart of FIG. 6.

In step S410 of the flowchart of FIG. 6, the entropy pool 42 periodically reads the timer value from the free-run timer 30 by the above-described periodic processing. Then, the entropy pool 42 pools, for example, one LSB bit of the timer value obtained in such manner. In step S420, the entropy pool 42 increments a count value of a pool counter by one. In step S430, the entropy pool 42 determines whether the count value of the pool counter has reached or exceeded the number of bits required for additional entropy. When it is determined that the count value is equal to or greater than the number of bits required for additional entropy, the entropy pool 42 proceeds to step S440. When it is determined that the counter value is less than the number of bits required for additional entropy, the entropy pool 42 repeats the processing from step S410.

In step S440, the entropy pool 42 sets the pooled bit string as additional entropy. Then, in step S450, the entropy pool 42 sets that the additional entropy obtaining processing has been complete, and ends the processing shown in the flowchart of FIG. 6.

The explanation will be continued by returning to the flowchart of FIG. 3. In step S140, which is performed subsequent to step S130, the seed generator 44 of the CPU 40 determines whether the HSM random number generation processing and the additional entropy obtaining processing are complete. When completion of the HSM random number generation processing is set in step S370 and completion of the additional entropy obtaining processing is set in step S450, the seed generator 44 determines that both the HSM random number generation processing and the additional entropy obtaining processing are complete, and proceeds the processing to step S150. On the other hand, when it is determined that at least one of the HSM random number generation processing and the additional entropy obtaining processing is not complete, the seed generator 44 waits until both processing are complete.

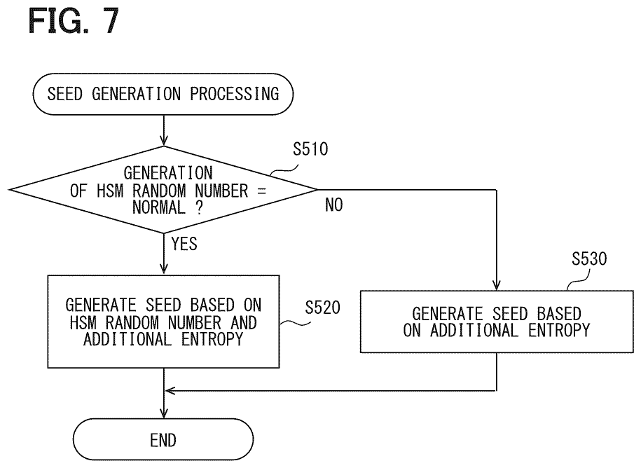

In step S150, the seed generator 44 of the CPU 40 performs seed generation processing. Details of this seed generation processing are shown in the flowchart of FIG. 7.

In the first step S510 of a flowchart of FIG. 7, the seed generator 44 determines whether generation of the HSM random number has been performed normally or whether generation of the HSM random number has been performed abnormally. Such determination can be made based on the processing results stored in step S350 or S360 described above. When it is determined that generation of the HSM random number has been performed normally, the seed generator 44 proceeds to step S520. On the other hand, when it is determined that generation of the HSM random number has been performed abnormally, the seed generator 44 proceeds to step S530.

In step S520, the seed generator 44 performs processing of generating a seed based on the HSM random number and the additional entropy according to the method described above. On the other hand, in step S530, the seed generator 44 performs processing of generating a seed based only on the additional entropy. Therefore, in the present embodiment, the seed generator 44 can generate a seed regardless of whether generation of the HSM random number has been performed normally or abnormally.

The explanation will be continued by returning to the flowchart of FIG. 3. In step S160, which is performed subsequent to step S150, the first PRNG 46 of the CPU 40 holds the seed given from the seed generator 44 as an internal state (initial value thereof). As a result, the first PRNG 46 is in a state where it can generate random numbers, for example, based on a predetermined encryption key and the held internal state. Therefore, in step S170, the CPU 40 (the first PRNG 46) is set to a random number generation enabled state. Thereafter, the processing shown in the flowchart of FIG. 3 ends.

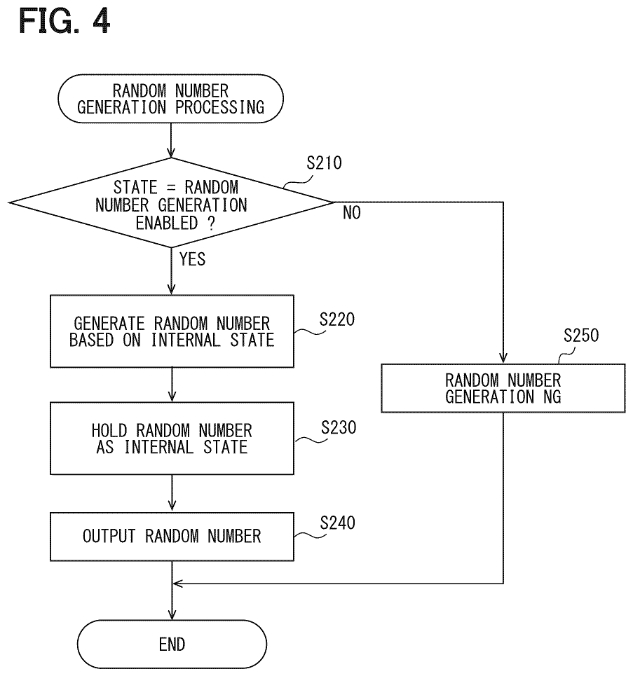

In response to reception of a random number output request from a target that uses random numbers, such as the device authenticator 48 shown in FIG. 1, random number generation processing shown in the flowchart of FIG. 4 is performed.

In the first step S210 of the flowchart of FIG. 4, the first PRNG 46 determines whether the seed or the generated random number is in a random number generation enabled state, which is held as an internal state. When it is determined that the random number generation enabled state is in effect, the first PRNG 46 proceeds to step S220. On the other hand, when it is determined that the random number generation enabled state is not in effect, the first PRNG 46 proceeds to step S250.

In step S220, random numbers (i.e., pseudo-random numbers), which are irregular bit strings, are generated according to a predetermined algorithm based on a predetermined encryption key and the internal state. Subsequently in step S230, the generated random number is held as the internal state of the first PRNG 46. Thereby, the first PRNG 46 is maintained in a state where it can generate random numbers. Then, in step S240, the first PRNG 46 outputs the generated random number to the target, such as the device authenticator 48, that has requested output of the random number.

### Second Embodiment

The following describes the second embodiment of the present disclosure. In the first embodiment described above, additional entropy is generated from the timer value of the free-run timer 30. However, additional entropy is generatable in various ways. In the present embodiment, some other examples of additional entropy generation methods will be described.

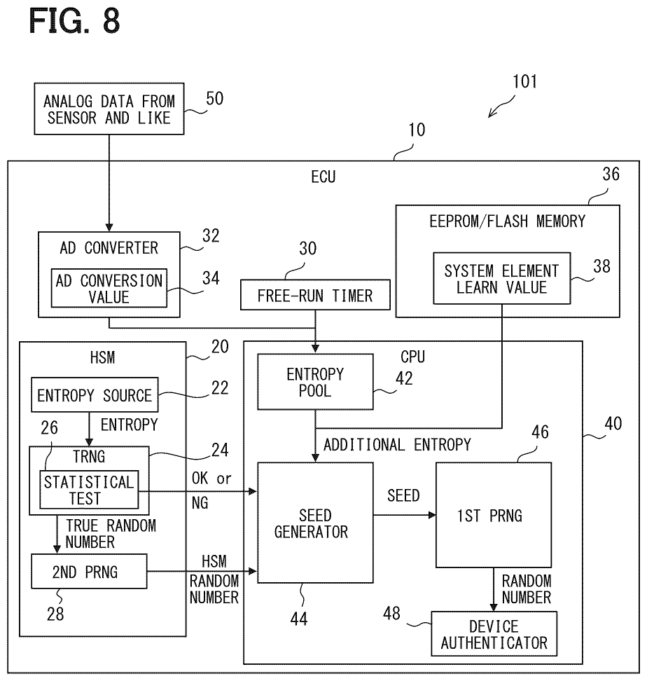

FIG. 8 is a configuration diagram showing an example of configuration of a random number generation device 101 according to the present embodiment. As shown in FIG. 8, the random number generation device 101 according to the present embodiment has an AD converter 32 and an EEPROM or flash memory 36 added to the random number generation device 1 of the first embodiment.

The AD converter 32 inputs analog data 50 from a sensor or the like, generates and outputs an AD conversion value 34 converted to digital data. The EEPROM or flash memory 36 stores control learn values 38 of system elements constituting a predetermined system controlled by the ECU 10.

For example, when the given system is a vehicle drivetrain system, one example of the system element may be a transmission. Then, when a relationship between an oil pressure used to change gears of the transmission and an electric current used to generate the oil pressure deviates from a desired relationship, the ECU 10 that controls the transmission stores, as a learn value, a correction value for correcting such deviation. Alternatively, when a predetermined system is a shift-by-wire system, an example of the system element may be a detent plate that is rotationally driven by an electric motor and switches a shift range according to a rotational position. In a shift-by-wire system, positioning control of the electric motor may be performed in order to make an output count value of an encoder that detects the rotational position of the electric motor correspond to the rotational position of the electric motor. In such positioning control, the electric motor is rotated up to a time when the detent plate attached to an output shaft of the electric motor comes into contact with a stopper wall set at an end of a movable range and stops. When the detent plate stops, the encoder output will no longer be generated. Therefore, the rotational position of the electric motor is known. In such state, a correction value for correcting the output count value of the encoder to a reference value is stored as a learn value.

Note that the learn values described above are merely examples, and the system to be controlled is not limited to the vehicle system. In any given system, the learn values used to control system elements are typically different from system to system. Therefore, by including the control learn values of the system elements in the input data (i.e., additional entropy) used by the seed generator 44 to generate seeds, it is possible to generate random numbers with high entropy.

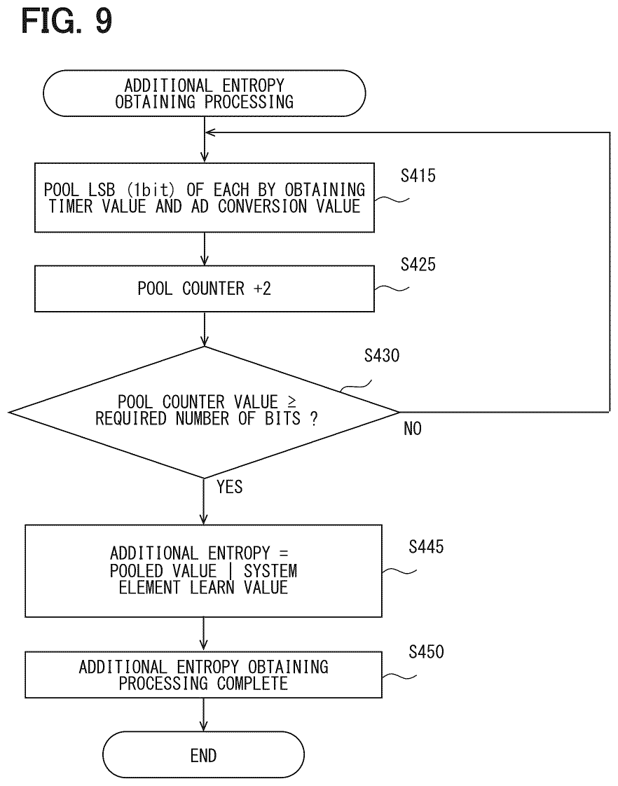

Next, several methods for generating additional entropy from the AD conversion value, timer value, and control learn value will be described in more detail with reference to a flowchart of FIG. 9. Note that in the additional entropy obtaining processing shown in the flowchart of FIG. 9, the processes of steps S410, S420, and S440 are deleted from the additional entropy obtaining processing shown in the flowchart of FIG. 6, and processes of steps S415, S425, S445 are added thereto. Other processing is common to both of additional entropy obtaining processing. Therefore, the points that are different from the additional entropy obtaining processing shown in the flowchart of FIG. 6 will be mainly explained in the following.

In step S415, the entropy pool 42 periodically reads the timer value from the free-run timer 30, and reads the AD conversion value from the AD converter 32. Here, the AD conversion value 34 of analog data from a sensor and the like includes variations due to quantization errors. Therefore, additional entropy is generatable from the AD conversion value 34. To generate additional entropy from the timer value and AD conversion value, it may be configured that, for example, the entropy pool 42 obtains the timer value and AD conversion value at approximately the same timing, and extracts 2 bits each from those values as LSB for pooling. Alternatively, the entropy pool 42 may obtain the timer value and the AD conversion value alternately at different timings, for example, and each time the timer value or AD conversion value is obtained, 1 bit of LSB of the timer value or AD conversion value may be pooled. The flowchart in FIG. 9 shows an example in which the timer value and the AD conversion value are obtained at approximately the same timing. Therefore, in step S415, the entropy pool 42 obtains the timer value and the AD conversion value, and pools 2 bits each from those values as LSB. Then, in step S425, the entropy pool 42 increments the count value of the pool counter by two.

In step S445, the entropy pool 42 generates additional entropy based on the pooled bit strings and the learn values of the system elements. Additional entropy may be generated based on the pooled bit string and the learn value of the system element, for example, by obtaining (a) some of the upper bits of the additional entropy from the pooled bit string and (b) the remaining bits of the lower bits of the additional entropy from the learn value of the system element. Alternatively, one piece of output data may be created using the above-mentioned cryptographic hash function using the pooled bit string and the learn value of the system element as two pieces of input data, and the output data may be used as the additional entropy.

Note that the additional entropy does not need to be created based on all of the above-mentioned timer values, AD conversion values, and learn values of the system element, and, for example, it may be created based on any combination of at least two values. Further, instead of the timer value of the free-run timer 30 in the first embodiment, an AD conversion value or a learn value of a system element may be used.

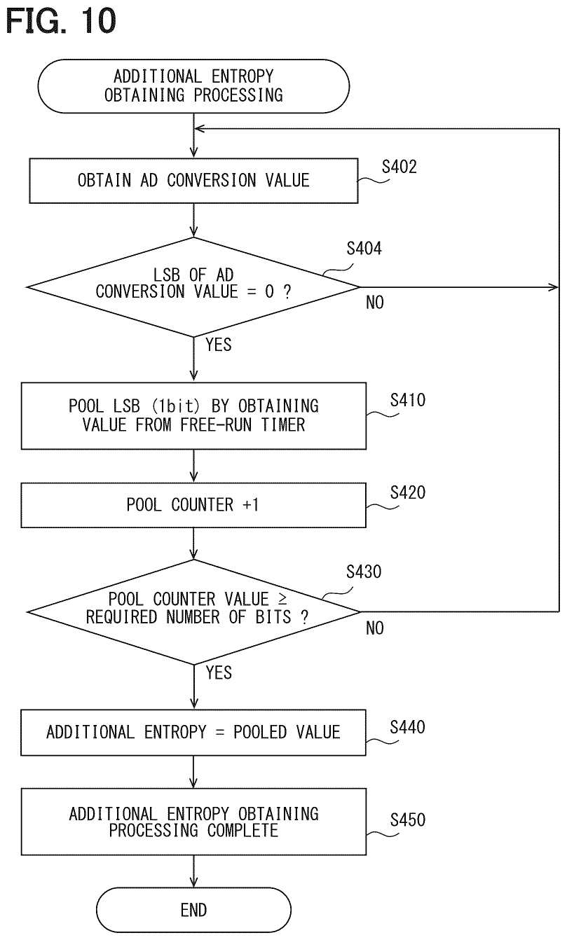

Here, an example of a method for generating additional entropy based on a combination of a timer value and an AD conversion value will be described with reference to a flowchart of FIG. 10. Note that the additional entropy obtaining processing shown in the flowchart of FIG. 10 has steps S402 and S404 added to the additional entropy obtaining processing shown in the flowchart of FIG. 6. Other processing is common to the additional entropy obtaining processing in both of FIGS. 6 and 10. Therefore, the points that are different from the additional entropy obtaining processing shown in the flowchart of FIG. 6 will be mainly explained in the following.

In step S402, the entropy pool 42 periodically or irregularly obtains the AD conversion value 34 from the AD converter 32. Then, in step S404, the entropy pool 42 determines whether the LSB of the AD conversion value 34 is zero. When the LSB of the AD conversion value 34 is 0, the entropy pool 42 proceeds to step S410, obtains the timer value from the free-run timer 30, and pools the LSB.

In the first embodiment described above, the timer value of the free-run timer 30 is periodically obtained. In contrast, in the example described above, the timer value of the free-run timer 30 is obtained at the timing when the LSB of the AD conversion value becomes zero. Thereby, the timing at which the timer value of the free-run timer 30 is obtained can be more reliably varied due to quantization errors of AD conversion values. As a result, additional entropy with higher entropy is generatable.

### Third Embodiment

Next, the third embodiment of the present disclosure is described. In the first embodiment described above, when it is determined that the generation of the HSM random number is abnormal, the seed generator 44 performs the processing of generating a seed based on the additional entropy.

Here, the indeterminacy of the additional entropy is lower than that of true random numbers. Therefore, when generation of the HSM random number is abnormal, a seed with lower entropy is generated than when it is normal. Therefore, unlimited generation of random numbers using seeds based on additional entropy may be undesirable in cases where high security is required.

Therefore, in the present embodiment, when generation of the HSM random numbers is abnormal, the number of times that seeds based on additional entropy are consecutively generated is limited to a predetermined number of times. As a result, the number of times a random number is generated using a seed based on additional entropy is also limited to a number corresponding to the predetermined number of times. Note that the random number generation device according to the present embodiment has the same configuration as the random number generation devices 1 and 101 according to the first embodiment or the second embodiment. Therefore, description regarding the configuration of the random number generation device according to the present embodiment will be omitted.

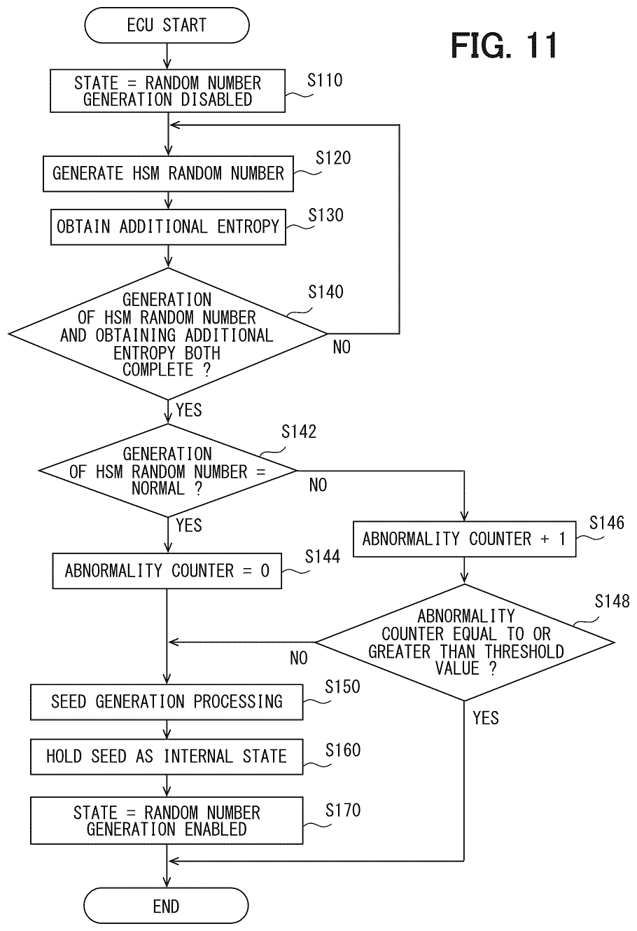

FIG. 11 shows a flowchart of processing regarding a flow up to a time when the seed generator 44 generates a seed based on the HSM random number from the HSM 20 and the additional entropy from the entropy pool 42 when the ECU 10 is started, according to the present embodiment. The flowchart shown in FIG. 11 has steps S142, S144, S146, and S148 added to the flowchart shown in FIG. 3. Other processing is common to both flowcharts. Therefore, the points that are different from the flowchart in FIG. 3 will be mainly explained in the following. Note that the processing shown in the flowchart of FIG. 11 is not only performed when the ECU is started, but is also repeatedly performed thereafter.

In step S142 of the flowchart in FIG. 11, the CPU 40 (for example, the seed generator 44) determines whether or not the HSM random number has been generated normally. When the HSM random number is normally generated, the CPU 40 proceeds to step S144. On the other hand, when there is an abnormality in generation of the HSM random number, the CPU 40 proceeds to step S146. In step S144, the CPU 40 resets, to zero, an abnormality counter that counts the number of times seeds have been generated based on additional entropy. Therefore, for example, even when it is determined at least once that generation of the HSM random number is abnormal, by thereafter repeating processing shown in the flowchart of FIG. 11 to lead to a determination that generation of the HSM random number is normally performed, the abnormality counter is reset to zero from a non-zero value.

In step S146, the CPU 40 increments the abnormality counter by one. The CPU 40 then proceeds to step S148, and determines whether the count value of the abnormality counter is equal to or greater than a threshold value. When the count value of the abnormality counter is less than the threshold value, the CPU 40 proceeds to step S150. In such case, as described above, a seed is created based on the additional entropy, and the seed is held in the first PRNG 46 as an internal state. On the other hand, when the CPU 40 determines in step S148 that the count value of the abnormality counter is equal to or greater than the threshold value, it skips steps S150, S160, and S170, and ends the processing shown in the flowchart of FIG. 11. Thereby, the number of times that seeds based on additional entropy are consecutively generated can be limited to a predetermined number of times that is less than the threshold value.

### Fourth Embodiment

Next, the third embodiment of the present disclosure is described. In the first embodiment described above, when it is determined that the HSM random number has been normally generated, the seed generator 44 performs the processing of generating a seed based on the HSM random number and the additional entropy.

In contrast, in the present embodiment, when it is determined that the HSM random numbers have been normally generated, the seed generator 44 performs processing of generating seeds based only on the HSM random numbers. In such manner, by generating seeds based only on the HSM random numbers, processing load for seed generation is reducible.

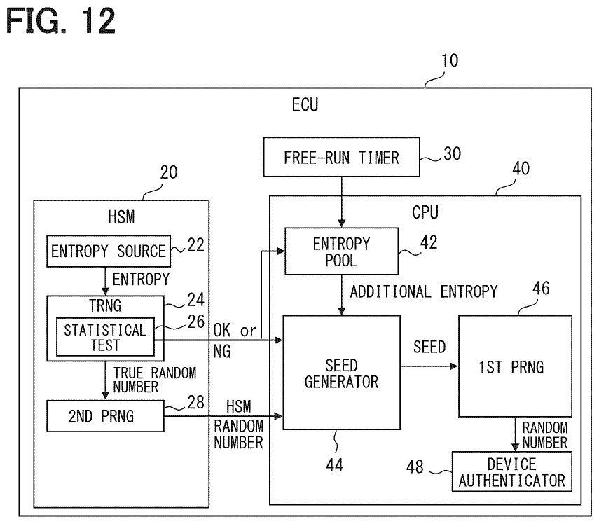

To perform the processing of generating seeds based only on the HSM random numbers when the HSM random numbers have been normally generated, for example, as shown in the configuration diagram of FIG. 12, the configuration is set such that the test results from the statistical tester 26 are also input to the entropy pool 42. Then, it is conceivable, in response to normal generation of the HSM random numbers, to configure the entropy pool 42 not to output additional entropy. And/or, it may also be conceivable, in response to normal generation of the HSM random number, for causing the seed generator 44 to perform processing for generating a seed based only on the HSM random number.

Although the preferred embodiments of the present disclosure have been described above, the present disclosure is not limited to the embodiments described above, and can be implemented with various modifications without departing from the gist of the present disclosure.

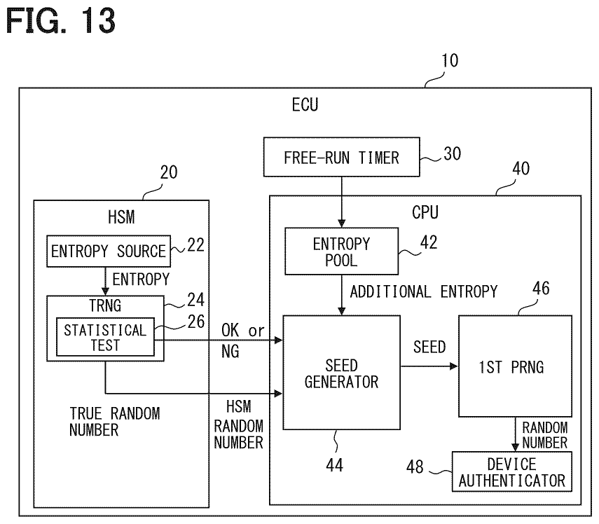

For example, in each of the embodiments described above, a configuration has been described in which, in the HSM 20, the second PRNG 28 generates pseudo-random numbers using a true random number from the TRNG 24 as a seed. However, as shown in FIG. 13, for example, the second PRNG 28 may be omitted and the true random numbers from the TRNG 24 may be output to the seed generator 44.

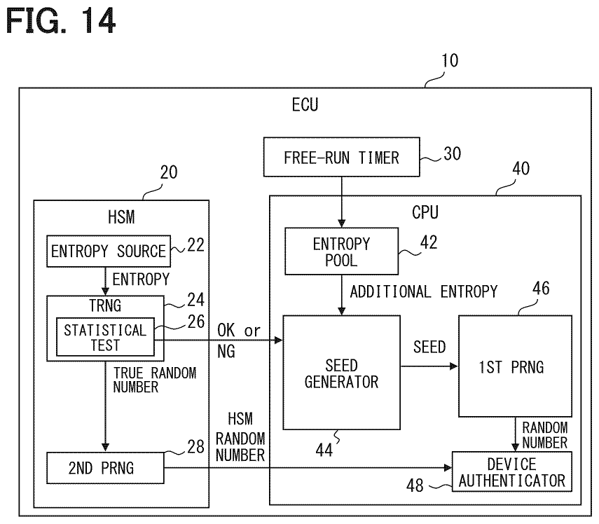

Further, in each of the embodiments described above, a configuration has been described in which pseudo-random numbers generated by the second PRNG 28 of the HSM 20 are given to the seed generator 44 as input data for generating seeds. However, as shown in FIG. 14, for example, the HSM random number generated by the second PRNG 28 may be output as the first random number to the device authenticator 48 that uses random numbers. In such case, the seed generator 44 generates a seed based on the additional entropy only when the result of the statistical test in the statistical tester 26 is NG and an abnormality has occurred in generation of the HSM random numbers. The first PRNG 46 generates a random number as a second random number, and outputs it to the device authenticator 48 only when the seed generator 44 generates a seed based on the additional entropy. Finally, this specification discloses a plurality of technical ideas listed below and a plurality of combinations thereof. The following combination of technical ideas applies not only to random number generation devices but also to random number generation methods.

In the present disclosure, the term “processor” may refer to a single hardware processor or several hardware processors that are configured to execute computer program code (i.e., one or more instructions of a program) included in a program. In other words, a processor may be one or more programmable hardware devices. For instance, a processor may be a general-purpose or embedded, specific-purpose processor and include, but not necessarily limited to, CPU (a Central Processing Unit), a microprocessor, GPU (a Graphics Processing Unit), and DFP (a Data Flow Processor).

The term “memory” in the present disclosure is a non-transitory, tangible storage medium and may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code constituting a program may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable devices. For instance, a circuit may be a customized IC (an Integrated Circuit) that is customized for a particular use and is configured as non-programmable.

In the present disclosure, the phrase “at least one of (i) a circuit and (ii) a processor” should be understood as disjunctive (i.e., logical disjunction) where the circuit and the processor can be optional and not be construed to mean “at least one of a circuit and at least one of a processor”. Therefore, in the present disclosure, the phrase “at least one of a circuit and a processor is configured to cause the random number generation device to perform functions” should be understood as “only the circuit can cause the random number generation device to perform all the functions”. Further, the phrase “at least one of a circuit and a processor is configured to cause the random number generation device to perform functions” should be understood as “only the processor can cause the random number generation device to perform all the functions”. Moreover, the phrase “at least one of a circuit and a processor is configured to cause the random number generation device to perform functions” should be understood as “the circuit can cause the random number generation device to perform at least one of the functions and the processor can cause the random number generation device to perform the remaining functions”. In the last example, if the random number generation device performs functions A to C, for example, the functions A and B among the functions A to C may be implemented by a circuit, while the remaining function C may be implemented by a processor.”

### Technical Idea 1

A random number generation device includes:
a first random number generator (24, 28, 44, 46) that generates, in a first entropy source (22), a first random number based at least on first entropy that is a true random number generated from a physical phenomenon;
a second random number generator (42, 44, 46) that generates a second random number based on second entropy obtained from a second entropy source (30); and
a determiner (26) that determines whether or not indeterminacy as entropy is ensured regarding the first entropy, wherein
it is configured that, (A) when the determiner determines that indeterminacy is ensured, the first random number generator generates the first random number, and (B) when the determiner determines that indeterminacy is not ensured, the second random number generator generates the second random number.

### Technical Idea 2

The random number generation device according to Technical Idea 1, wherein
the first random number generator includes:
a first pseudo-random number generator (46) that uses a seed as an initial value of an internal state to generate a pseudo-random number according to the internal state, and determines a next internal state, and
the first random number is generated by the first pseudo-random number generator by providing, to the first pseudo-random number generator, the seed that is based on the first entropy.

### Technical Idea 3

The random number generation device according to Technical Idea 2, wherein
the first random number generator includes:
a seed generator (44) that generates the seed to be given to the first pseudo-random number generator, and
the first random number is generated by the first pseudo-random number generator by providing, to the first pseudo-random number generator, the seed generated by the seed generator based on the first entropy and second entropy.

### Technical Idea 4

The random number generation device according to Technical Idea 1, wherein
the first random number generator includes:
a first pseudo-random number generator (46) that uses the seed as an initial value of an internal state to generate a pseudo-random number according to the internal state, and determines a next internal state; and
a second pseudo-random number generator (28) different from the first pseudo-random number generator, wherein
the seed based on the first entropy is given to the second pseudo-random number generator, and
the first random number is generated by the first pseudo-random number generator by giving the seed based on the random number generated by the second pseudo-random number generator to the first pseudo-random number generator.

### Technical Idea 5

The random number generation device according to Technical Idea 4, wherein
the first random number generator includes:
a seed generator that generates the seed to be given to the first pseudo-random number generator, and
the first random number is generated by the first pseudo-random number generator, by providing, to the first pseudo-random number generator, the seed generated by the seed generator based on the random number generated by the second pseudo-random number generator and the second entropy.

### Technical Idea 6

The random number generation device according to Technical Idea 3 or 5, wherein
the seed generator uses a cryptographic hash function when generating the seed from two inputs.

### Technical Idea 7

The random number generation device according to any one of Technical Ideas 2 to 6, wherein
the first pseudo-random number generator is shared by the first random number generator and the second random number generator, and
the second random number is generated by the first pseudo-random number generator by giving the seed based on the second entropy to the first pseudo-random number generator.

### Technical Idea 8

The random number generation device according to Technical Idea 7, further comprising:
a limiter (S142, S146, S148) that limits a number of times seeds are consecutively created based on the second entropy to a predetermined number of times.

### Technical Idea 9

Random number generation device according to any one of Technical Ideas 1 to 8, wherein
the second entropy is generated based on at least one of a timer value of a free-run timer, a conversion value of an AD converter, and a control learn value.

### Technical Idea 10

The random number generation device according to Technical Idea 9, wherein
the second entropy is generated based on the timer value of the free-run timer, which is obtained every time the conversion value of the AD converter becomes a predetermined value.

### Technical Idea 11

An electronic control device comprising the random number generation device according to any one of Technical Ideas 1 to 10.

What is claimed is:

1. A random number generation device, comprising:
a first random number generator that is configured to generate, in a first entropy source, a first random number based at least on first entropy that is a true random number generated from a physical phenomenon;
a second random number generator that is configured to generate a second random number based on second entropy obtained from a second entropy source; and
a determiner that is configured to determine whether indeterminacy as entropy is ensured regarding the first entropy, wherein
the first random number generator is further configured to generate the first random number when the determiner determines that indeterminacy is ensured, and
the second random number generator is further configured to generate the second random number when the determiner determines that indeterminacy is not ensured.

2. The random number generation device according to claim 1, wherein
the first random number generator includes a first pseudo-random number generator that is configured to:
generate a pseudo-random number according to an internal state using a seed as an initial value of the internal state; and
determine a next internal state, and
the first random number is generated by the first pseudo-random number generator by giving, to the first pseudo-random number generator, the seed that is based on the first entropy.

3. The random number generation device according to claim 2, wherein
the first random number generator includes a seed generator that is configured to generate the seed to be given to the first pseudo-random number generator, and
the first random number is generated by the first pseudo-random number generator by giving, to the first pseudo-random number generator, the seed generated by the seed generator based on the first entropy and the second entropy.

4. The random number generation device according to claim 1, wherein
the first random number generator includes:
a first pseudo-random number generator that is configured to:
generate a pseudo-random number according to an internal state using the seed as an initial value of the internal state; and
determine a next internal state; and
a second pseudo-random number generator that is different from the first pseudo-random number generator, wherein
the seed based on the first entropy is given to the second pseudo-random number generator, and
the first random number is generated by the first pseudo-random number generator by giving the seed based on the random number generated by the second pseudo-random number generator to the first pseudo-random number generator.

5. The random number generation device according to claim 4, wherein
the first random number generator includes a seed generator that is configured to generate the seed to be given to the first pseudo-random number generator, and
the first random number is generated by the first pseudo-random number generator, by giving, to the first pseudo-random number generator, the seed generated by the seed generator based on the random number generated by the second pseudo-random number generator and the second entropy.

6. The random number generation device according to claim 3, wherein
the seed generator is configured to generate the seed from two inputs using a cryptographic hash function.

7. The random number generation device according to claim 2, wherein
the first pseudo-random number generator is shared by the first random number generator and the second random number generator, and
the second random number is generated by the first pseudo-random number generator by giving the seed based on the second entropy to the first pseudo-random number generator.

8. The random number generation device according to claim 7, further comprising
a limiter, wherein
seeds are consecutively created based on the second entropy, and
the limiter is configured to limit a number of times of generation of the seeds to a predetermined number of times.

9. The random number generation device according to claim 1, wherein
the second entropy is generated based on at least one of a timer value of a free-run timer, a conversion value of an AD converter, and a control learn value.

10. The random number generation device according to claim 9, wherein
the second entropy is generated based on the timer value of the free-run timer obtained every time the conversion value of the AD converter reaches a predetermined value.

11. An electronic control device, comprising
the random number generation device according to claim 1.

12. A random number generation method performed by at least one processor, the method comprising:
generating a first random number based at least on a first entropy that is a true random number generated by physical phenomenon in a first entropy source;
determining whether indeterminacy as entropy is ensured for the first entropy;
generating the first random number upon determining that the indeterminacy of the first entropy is ensured; and
generating a second random number based on second entropy obtained from a second entropy source upon determining that indeterminacy of the first entropy is not ensured.

13. A random number generation device, comprising
at least one of (i) a circuit and (ii) a processor having a memory storing computer program code, wherein
the at least one of the circuit and the processor is configured to cause the random number generation device to:
generate, in a first entropy source, a first random number based at least on first entropy that is a true random number generated from a physical phenomenon;
generate a second random number based on second entropy obtained from a second entropy source; and
determine whether indeterminacy as entropy is ensured regarding the first entropy, wherein
the at least one of the circuit and the processor is further configured to cause the random number generation device to:
generate the first random number upon determining that indeterminacy is ensured; and
generate the second random number upon determining that indeterminacy is not ensured.
